(19) United States
(12) Patent Application Publication
(10) Pub. No.: US 2012/0113647 A1
(43) Pub. Date: May 10, 2012

(54) LED LAMP HAVING AN ANION GENERATOR

(76) Inventor: Cheong-Ho Lee, Seoul (KR)

(21) Appl. No.: 13/384,293

(22) PCT Filed: Jul. 14, 2010
(86) PCT No.: PCT/KR2010/004588

§ 371 Date: Jan. 16, 2012

(30) Foreign Application Priority Data
Jul. 15, 2009 (KR) 10-2009-0064284

(51) Int. Cl. F21V 33/00

(52) U.S. Cl. 362/253

(57) ABSTRACT

The present invention relates to an anion lamp having an LED as a light source, and an anion generator arranged in the anion lamp. The anion lamp comprises a main body 10 having a connecting socket terminal 11 formed at the top thereof and an open hole 12 formed at the bottom thereof; an LED module 20 installed such that an LED 21 is outwardly exposed from the main body 10 via the open hole 12 of the main body 10; a metal fiber 30 which penetrates through the center of the LED module 20 from the anion generator to be exposed outwardly and downwardly from the main body 10; and a lamp shade 40 attached to a lower end of the main body. The top of the lamp shade 40 has a ring 41. The lower end of the main body 10 has an outer circumferential surface on which a plurality of heat-dissipating holes 13 are in communication with the LED module 20. The connecting socket terminal 11 of the main body 10 has a lower outer circumference on which a plurality of heat-dissipating bores 13A are in communication with an internal space of the main body 10. The thus-configured lamp of the present invention guides airflow around the metal fiber using the lamp shade, and the surface of the lamp shade is coated with a photocatalyst layer to minimize the amount of dust accumulating on the lamp shade. The lamp of the present invention easily dissipates heat generated during the emission of the light by the LED, thereby lengthening the lifespan of the LED.

### TECHNICAL FIELD

The present invention relates to an LED lamp having an anion generator, and particularly, to an LED lamp having an anion generator, which has an LED as a light source for illuminating an indoor space and uses the anion generator so as to purify indoor air, and which can efficiently dissipate heat generated from the LED and also can prevent cations from being accumulated at the LED light source due to the generation of anions from the anion generator.

### BACKGROUND ART

In general, indoor air contains various germs and dust which are harmful to the human body, and thus if humans breathe the air in the body through the respiratory tract, it may be dangerous to health.

Recently, as interest in health is increased steadily due to improvement of the living standards, an air cleaner, an anion generator, a humidifier and the like are widely used in the home so as to purify the germs and dust and thus maintain the indoor air cleanly and pleasantly.

Among the various air treating devices used in the room, it is known that the anion generator has various effects of neutralizing bad smell or the like in the air so as to prevent the propagation of germs, neutralizing harmful electromagnetic waves generated from electromagnetic instruments so as to cure and prevent eyesight deterioration, insomnia, neuralgia, and also invigorating the human body so as to recover fatigue and relieve stress. Thus, an anion generator for generating anions only is proposed and used widely.

However, in case of the anion generator for generating anions only, there are some inconveniences that it has a high price and requires a separate installation space. To solve the inconveniences, the anion generator is disposed at a lamp which is installed on the ceiling so as to illuminate an indoor space and also to purify indoor air.

One of the examples, there has been proposed an anion generator using LED disclosed in Korean U.M. Registration No. 421556. Herein, as shown in FIG. 1, the anion generator includes a housing 100 of which one end is opened so as to couple a socket, an LED module 110 which is disposed in the housing 100, a lamp cover 120 which is disposed at an opened surface of the housing 100 so as to pass light, and a metal fiber 130 which is extended from the LED module 110 so as to be protruded over the lamp cover 120.

The anion generator functions to basically generate anions and to absorb and remove cations such as dust contained in the air. Therefore, cationic substances are collected around the anion lamp, and thus a large quantity of dust is accumulated on the lamp cover.

In this case, it is necessary to remove the dust accumulated on the lamp cover. To this end, the lamp cover is firstly separated from the lamp so as to remove the dust and then installed again to the lamp. However, in the above-mentioned anion generator, since the metal fiber has a very long length so that it is protruded over the lamp cover, the metal fiber is bent when installing again the lamp cover, and it takes a lot of time to reinstall the lamp cover, and also the metal fiber may be broken, and thus it is not easy to reinstall the lamp cover. Additionally, when the metal fiber is used for a long period of time, macromolecular oil mist, nicotine, tar and the like are accumulated at an end of the metal fiber, and thus the anions may be not facilely emitted from the metal fiber.

Further, since the lamp cover 120 completely encloses the LED as a light source, it is difficult to dissipate heat generated from the LED, and thus the lifespan of the LED is reduced.

Furthermore, since the LED is enclosed by the lamp cover 120, it is difficult to provide beautiful appearance.

### DISCLOSURE

[Technical Problem]

An object of the present invention is to provide an LED lamp having an anion generator, in which air flow is induced around the metal fiber so as to minimize the dust accumulated on a lamp shade, and the lamp shade can be easily separated so as to remove the dust and then installed again without any damage to it, and also the heat generated from the LED can be facilely dissipated to the outside, thereby increasing the lifespan of the LED.

Another object of the present invention is to provide an LED lamp having an anion generator, which can illuminate the indoor space with various colors, thereby creating various ambiences.

[Technical Solution]

To achieve the object of the present invention, the present invention provides an LED lamp having an anion generator, in which a conical lamp shade is removably attached to a main body, and the main body is formed with heat-dissipating holes, through-holes and heat-dissipating bores which are communicated with an internal space of the main body.

[Advantageous Effects]

According to the present invention as described above, the air flow is induced around the metal fiber and also a photocatalyst is coated on the lamp shade so as to provide a self-purification function for antifouling, antibiosis, removing of bad smell and decomposing of harmful substances, thereby minimizing the dust accumulated on the lamp shade, and the lamp shade can be easily separated so as to remove the dust and then installed again without any damage to it.

Further, even though the macromolecular oil mist, nicotine, tar and the like are accumulated at the end of the metal fiber, the metal fiber cab be easily separated and replaced with new one, and also it is possible to solve the problem that the anion emission is not facilely performed due to the accumulation of the macromolecular oil mist, nicotine, tar and the like when the metal fiber is used for a long period of time. Further, since it is easy to dissipate heat generated from the LED, the lifespan of the LED is increased. Also, it is possible to provide beautiful appearance and to illuminate the indoor space with various colors, thereby creating various ambiences.

### DESCRIPTION OF DRAWINGS

The above and other objects, features and advantages of the present invention will become apparent from the following description of preferred embodiments given in conjunction with the accompanying drawings, in which:

FIG. 1 is a cross-sectional view of a conventional anion lamp using LED.

FIG. 2 is a perspective view of an anion lamp using LED according to the present invention.

FIG. 3 is an exploded perspective view of FIG. 2.

FIG. 4 is a bottom view of the anion lamp using LED according to the present invention.

FIG. 5 is a cross-sectional view of the anion lamp using LED according to the present invention.

FIG. 6 is a cross-sectional view of the anion lamp using LED according to another embodiment of the present invention.

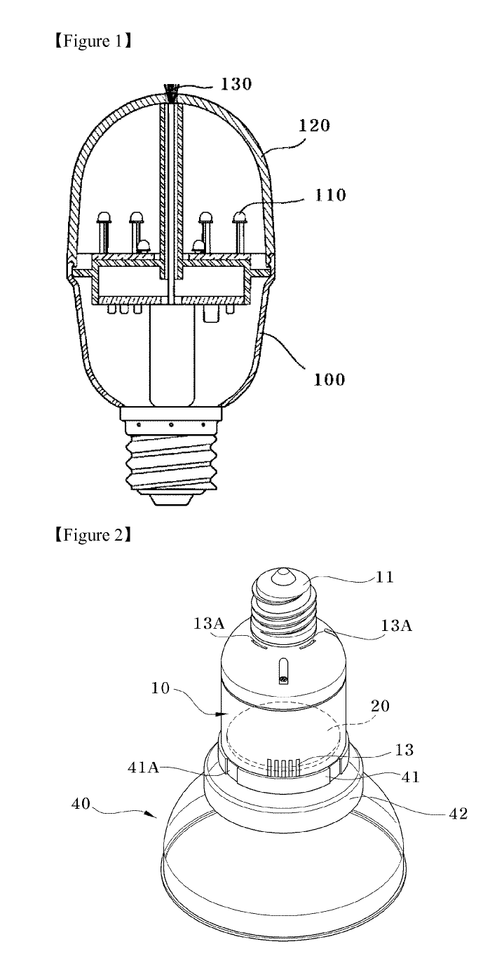

[Detailed Description of Main Elements]

| | | | |
|---|---|---|---|
| 10: | main body | 10A: | connecting hole |
| 11: | socket terminal | 12: | open hole |
| 13: | heat-dissipating hole | 13A: | heat-dissipating bore |
| 20: | LED module | 21: | LED |
| 30: | metal fiber | 31: | separation type metal fiber |
| 31A: | protrusion | 32: | lead portion |
| 32A: | installing groove | 40: | lamp shade |
| 40A: | through-hole | 41: | ring |
| 41A: | installing protrusion | 42: | cover |
| 43: | guide hole | 44: | photocatalyst |

### BEST MODE

The present invention includes a main body 10 having a connecting socket terminal 11 formed at the top thereof and an open hole 12 formed at the bottom thereof; an LED module 20 disposed in the main body 10 and installed such that an LED 21 is outwardly exposed from the main body 10 via the open hole 12 of the main body 10; a metal fiber 30 which penetrates through the center of the LED module 20 from the anion generator to be exposed outwardly and downwardly from the main body 10; and a lamp shade 40 which is attached to a lower end of the main body 10 and of which an upper circumference is less than a lower circumference, wherein the top of the lamp shade 40 has a ring 41, and a cover 42 which is curved downwardly to have a convex shape is provided in an upper side of the lamp shade 40, and the lower end of the main body 10 has an outer circumferential surface on which a plurality of heat-dissipating holes 13 are in communication with the LED module 20, and the connecting socket terminal 11 of the main body 10 has a lower outer circumference on which a plurality of heat-dissipating bores 13A are in communication with an internal space of the main body 10, and the center portion of the cover 42 has a guide hole 43 through which the metal fiber 30 is passed from the main body 10, and through-holes 40A are respectively formed at an edge portion of the cover so as to be corresponding to the heat dissipating holes 13.

Hereinafter, the embodiments of the present invention will be described in detail with reference to accompanying drawings.

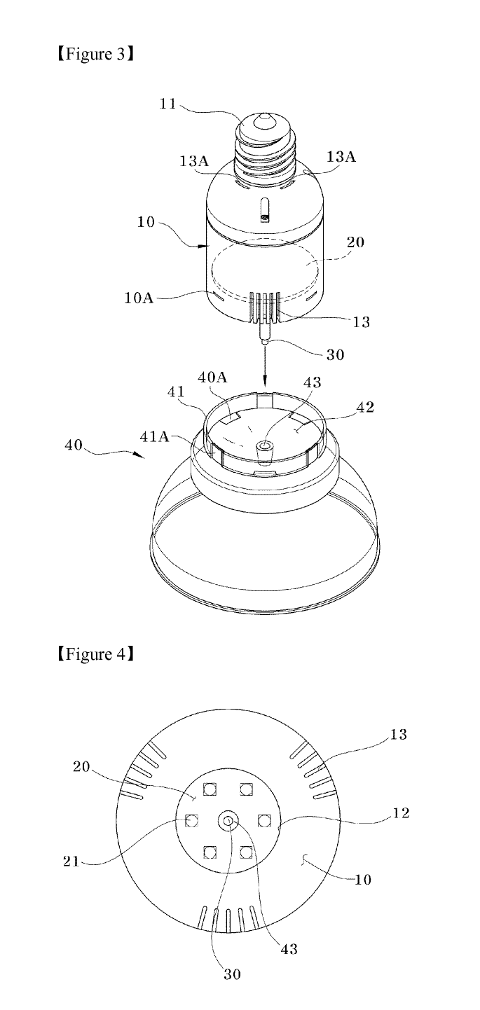

FIG. 2 is a perspective view of an anion lamp using LED according to the present invention, and FIG. 3 is an exploded perspective view of FIG. 2. As shown in the drawings, the present invention includes a main body 10; an LED module 20 which disposed in the main body 10; a metal fiber 30 which penetrates through the center of the LED module 20 to be exposed outwardly; and a lamp shade 40 of which an upper circumference is less than a lower circumference.

The main body 10 has a cylindrical shape formed of a synthetic resin. The main body 10 is formed with an internal receiving space which receives an anion generator (not shown) having an anion generating circuit and also receives the LED module at a lower portion thereof, and a bottom surface is formed at a lower side of the internal receiving space. An open hole 12 is formed at the center portion of the bottom surface, and an LED 21 is outwardly exposed from the main body 10 via the open hole 12 of the main body 10.

At the top of the body, there are disposed an anion generator and a socket terminal 11 for supplying power to the LED module 20. The socket terminal 11 has a screw formed at an outer surface thereof, and a plurality of heat-dissipating bores 13A disposed at a lower side of the screw of the socket terminal 11 are formed in an outer surface of the main body 10 so as to be spaced apart at regular intervals, such that air introduced through heat-dissipating holes 13 to be described below cools the LED module 20 disposed in the main body 10 and then discharged through the heat-dissipating bores 13A, thereby efficiently cooling the LED module 20.

The plurality of heat-dissipating holes 13 communicated with the LED module 20 disposed in the main body 10 are formed in a lower outer surface of the main body so as to be spaced apart at regular intervals. The heat-dissipating holes 13 consist of a plurality of long holes which are formed vertically. The heat-dissipating holes 13 are connected with through-holes 40A which are formed in an edge portion of a lamp shade 40 to be described below. External air can be freely introduced into the LED module 20 through the through-holes 40A and the heat-dissipating holes 13 and then discharged through the heat-dissipating bores 13A formed at the upper portion of the main body 10, and thus the LED module 20 and LED 21 are prevented from being deteriorated.

The LED module 20 is modularized by installing the plurality of LEDs 21 on a substrate. In the center portion of the LED module 20, there is formed a through-hole through which a metal fiber 30 to be described below is protruded from the anion generator disposed at an upper side of the LED module 20 via the LED module 20 to an outside disposed at a lower side of the main body 10.

The metal fiber 30 is extended from the anion generator in the main body 10. The metal fiber 30 is coated with silver nano-particles for increasing sterilization effect and then coated with a synthetic resin, and an end of the metal fiber 30 is not coated to be exposed to an outside, such that anions generated from the anion generator can be emitted to the air.

Meanwhile, since the end of the metal fiber 30 is exposed to the air, macromolecular oil mist, nicotine, tar and the like are accumulated thereon, and thus the anions cannot be facilely emitted from the anion generator, or the efficiency of anion emission is deteriorated. In the present invention, the metal fiber 30 is allowed to be replaced with new one so that a proper amount of anions can be always generated.

To this end, as shown in FIG. 6, the metal fiber 30 consists of a lead portion 32 which has a length extended to a cover 42 of the lamp shade 40 and also has an installing groove 32A formed at an end thereof so as to be apply electric power, and a separation type metal fiber 31 which has a protrusion 31A fixed to the installing groove 32A of the lead portion 32.

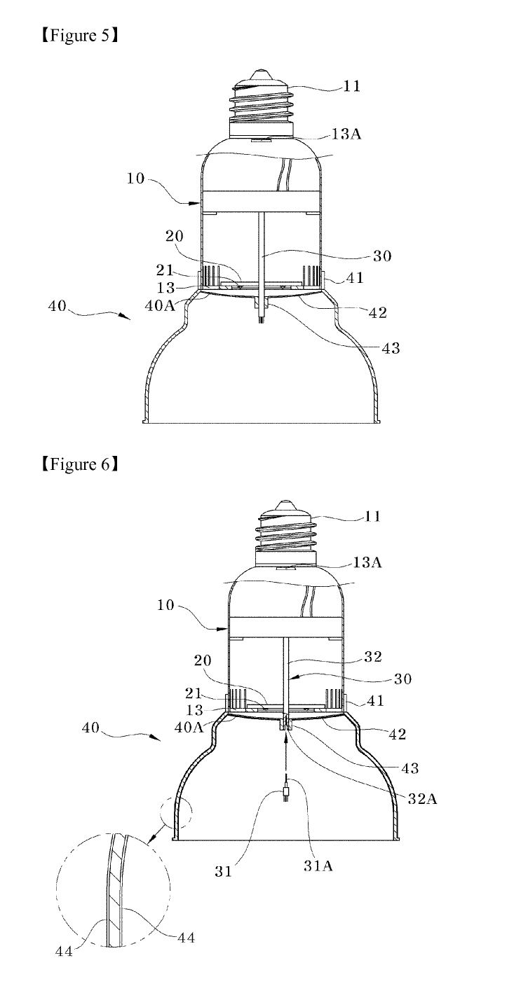

As shown in FIGS. 4 and 5, the lamp shade 40 which is formed of transparent polycarbonate (so called “PC”) and of which an upper circumference is less than a lower circumference is attached to a lower end of the main body 10. To this end, a plurality of connecting holes 10A are formed in a lower outer surface of the main body so as to be spaced apart in its circumferential direction at regular intervals. A ring 41 having a diameter which can receive a lower circumference of the main body 10 is provided at an upper portion of the lamp shade 40, and multiple installing protrusions 41A are formed at the ring 41 so as to be spaced apart in its circumferential direction at regular intervals. The installing protrusions 41A is fitted to the connecting holes 10A formed at the lower portion of the main body, and thus the lamp shade 40 can be easily coupled to and separated from the lower outer surface of the main body 10.

When the ring 41 of the lamp shade 40 is coupled to the lower outer surface of the main body 10, part of the heat-dissipating holes 13 formed in the lower outer surface of the main body 10 are covered by the ring 41. In the present invention, a longitudinal length of each heat-dissipating hole 13 is formed to be larger than a length of the ring 41 so that function of the heat-dissipating holes 13 can be smoothly performed even though part of the heat-dissipating holes 13 are covered by the ring 41. Since the lamp shade 40 is formed of the transparent polycarbonate which has a smooth surface and a high transmittance, it is possible to prevent glare and also to increase the light transmittance.

At an upper side of the lamp shade, there is formed a cover 42 which is curved downwardly to have a convex shape, and a lower portion of the lamp shade 40 is opened.

As described above, since the plurality of through-holes 40A are formed at the edge portion of the cover 42 to be corresponding to the heat-dissipating holes 13 formed at the lower portion of the main body 10, the air introduced through the through-holes 40A cools the LED module and then discharged through the heat-dissipating bores 13A formed at the upper portion of the main body 10 to the outside.

At the center portion of the cover 42, there is formed the guide hole 43 through which the metal fiber 30 is passed from the main body 10 and then protruded to an outside of the cover 42. Herein, the protruded metal fiber 30 has a limited length so that an end thereof is maintained in the lamp shade 40.

Herein, the guide hole 43 may be formed to be protruded to a bottom surface of the cover 42, and thus the coated metal fiber 30 can be firmly supported without bending thereof.

As described above, the lamp shade has the narrow upper circumference and the wide lower circumference. Herein, air flow in the lamp shade 40 as well as the amount of dust accumulated on the lamp shade 40 is changed according to a size and height of the lower diameter of the lamp shade 40. As a result of experience, when the lamp shade 40 preferably has an inclined angle of 25˜35 degrees with respect to a vertical center line and a length of about 5˜7 cm, the anions can be efficiently emitted and the amount of dust accumulated on the lamp shade 40 is minimized.

Meanwhile, in order to decompose the dust accumulated on the lamp shade 40 and thus to obtain the sterilization and deodorization effects, the lamp shade 40 may have a photocatalyst layer of TiO₂.

### INDUSTRIAL APPLICABILITY

Further, in the present invention, the lamp shade 40 is formed with a transparent material, but the LEDs 21 may consist of colored LEDs so as to provide different effects.

For example, a white color helps treatment of a melancholiac, a blue color provides psychological stability and reduces a blood pressure and an inflammation, a green color provides an anticarcinogenic effect, a red color promotes blood circulation, and an orange color increases insulin secretion and thus helps treatment of diabetic patients. As described above, the color of the LED 21 can be changed depending to the using purpose of the lamp, and thus it is possible to obtain the sterilization and deodorization effects as well as various additional effects such as improvement of heath and leaning ability and a growth promoting effect of plants.

While the present invention has been described with respect to the specific embodiments, it will be apparent to those skilled in the art that various changes and modifications may be made without departing from the spirit and scope of the invention as defined in the following claims.

1. An anion lamp having an LED as a light source and an anion generator arranged therein, comprising:
a main body 10 having a connecting socket terminal 11 formed at the top thereof and an open hole 12 formed at the bottom thereof;
an LED module 20 disposed in the main body 10 and installed such that an LED 21 is outwardly exposed from the main body 10 via the open hole 12 of the main body 10;
a metal fiber 30 which penetrates through the center of the LED module 20 from the anion generator to be exposed outwardly and downwardly from the main body 10; and
a lamp shade 40 which is attached to a lower end of the main body 10 and of which an upper circumference is less than a lower circumference,
wherein the top of the lamp shade 40 has a ring 41, and a cover 42 which is curved downwardly to have a convex shape is provided in an upper side of the lamp shade 40, and the lower end of the main body 10 has an outer circumferential surface on which a plurality of heat-dissipating holes 13 are in communication with the LED module 20, and the connecting socket terminal 11 of the main body 10 has a lower outer circumference on which a plurality of heat-dissipating bores 13A are in communication with an internal space of the main body 10, and the center portion of the cover 42 has a guide hole 43 through which the metal fiber 30 is passed from the main body 10, and through-holes 40A are respectively formed at an edge portion of the cover so as to be corresponding to the heat dissipating holes 13.

2. The anion lamp according to claim 1, wherein the guide hole 43 has length that extended to a bottom surface of the cover 42.

3. The anion lamp according to claim 1, wherein the surface of the lamp shade 40, which connected to the lower end of the main body 10, is coated with a photocatalyst layer of TiO₂.

4. The anion lamp according to any one of claims 1 to 3, wherein the metal fiber 30 comprises a lead portion 32 which has a length extended to a cover 42 of the lamp shade 40 and also has an installing groove 32A formed at an end thereof so as to be apply electric power; and a separation type metal fiber 31 which has a protrusion 31A fixed to the installing groove 32A of the lead portion 32.
